(19) United States
(12) Patent Application Publication
(10) Pub. No.: US 2024/0174216 A1
(43) Pub. Date: May 30, 2024

(54) INFORMATION PROCESSING SYSTEM

(71) Applicant: TOYOTA JIDOSHA KABUSHIKI KAISHA, Toyota-shi Aichi-ken (JP)

(72) Inventors: Tomohiro KANEKO, Mishima-shi Shizuoka-ken (JP); Shigeki NAKAYAMA, Gotenba-shi Shizuoka-ken (JP); Kotoru SATO, Hadano-shi Kanagawa-ken (JP)

(73) Assignee: TOYOTA JIDOSHA KABUSHIKI KAISHA, Toyota-shi Aichi-ken (JP)

(21) Appl. No.: 18/379,214

(22) Filed: Oct. 12, 2023

(30) Foreign Application Priority Data
Nov. 24, 2022 (JP) 2022-187785

(51) Int. Cl. B60W 30/00; G06V 20/56; G06V 20/59

(52) U.S. Cl. CPC B60W 30/00; G06V 20/56; G06V 20/597; B60W 2540/22; B60W 2556/50

(57) ABSTRACT

An information processing system includes: a mounting device, mounted on a moving body, acquiring position information of the moving body; and an information processing device receive and transmit information with the mounting device. Further, the mounting device inputs a captured image of an occupant to a learning model, outputs an estimation result of an emotion of the occupant, and, when determined the emotion of the occupant is a negative, transmits date and time information and the position information of the moving body at a time when the negative emotion is appeared to the information processing device, and the information processing device acquires and stores the date and time information and the position information from the movable body in a storage unit, and identifying a location or date and time when a specific rule occurs.

### CROSS-REFERENCE TO RELATED APPLICATION (S)

The present application claims priority to and incorporates by reference the entire contents of Japanese Patent Application No. 2022-187785 filed in Japan on Nov. 24, 2022.

### BACKGROUND

The present disclosure relates to an information processing system.

Japanese Laid-open Patent Publication No. 2010-112798 proposes a technique for notifying the local rule to the user when a degree of enforcement of a safe driving is low.

### SUMMARY

There is a need for providing an information processing system capable of efficiently identifying the place and time where specific rules exist.

According to an embodiment, an information processing system includes: a mounting device, mounted on a moving body, acquiring position information of the moving body; and an information processing device receiving and transmitting information from and to the mounting device. Further, the mounting device includes a moving body control unit inputting a captured image of an occupant in the moving body to a learning model as an input parameter, outputting an estimation result of an emotion of the occupant as an output parameter, and, when it is determined that the emotion of the occupant is a negative emotion on a basis of the output estimation result, transmitting date and time information and the position information of the moving body at a time when the negative emotion is appeared to the information processing device, and the information processing device includes a control unit acquiring the date and time information and the position information transmitted from the movable body and store the date and time information and the position information in a storage unit, and identifying a location or date and time when a specific rule occurs on a basis of a number of the stored position information and the date and time information.

### BRIEF DESCRIPTION OF THE DRAWINGS

FIG. 1 is a schematic diagram illustrating an information processing system according to an embodiment;

FIG. 2 is a block diagram illustrating an information processing system according to an embodiment;

FIG. 3 is a diagram for explaining a flow of estimating a negative emotion of an occupant of a vehicle according to an embodiment;

FIG. 4 is a flowchart for explaining an information processing method according to an embodiment; and

FIG. 5 is a flowchart for explaining a method of notifying a vehicle of occurrence of a local rule obtained by an information processing method according to an embodiment.

### DETAILED DESCRIPTION

In driving a vehicle, specific rules, so-called local rules, exist and are diversified. Local rules may exist for each area. Such local rules may vary according to the age, location, time, and other conditions. However, it is time consuming to collect such local rules including this diversified and specific traffic rule. Therefore, a technique for efficiently identifying where local rules (specific rules) are occurring is desired.

Hereinafter, embodiments of the present disclosure will be described with reference to the accompanying drawings. Incidentally, in the entire drawing of one embodiment below, the same or corresponding parts are denoted by the same reference numerals. In addition, the present disclosure is not limited by the embodiments described below.

In an embodiment of the present disclosure, in a vehicle as a moving object traveling on a road, an emotion of an occupant appearing in the vehicle is estimated using a learning model. The learning model is simply referred to as a trained model, a trained model, or a trained model. When the emotion of the occupant is a negative emotion as a result of estimating the emotion of the occupant, the control unit of the vehicle in which the occupant who has expressed the negative emotion is aboard transmits the position information of the position where the negative emotion is expressed to the occupant and the time information of the date and time of the expression to the predetermined server. Incidentally, the negative emotion, such as scorching, surprises and anxiety is not necessarily limited. This allows the location where a specific traffic rule (hereafter local rule) is occurring to be identified based on the amount of notifications received by the server. “Based on the amount of notification” is, for example, a case where the position information of approximately equal positions is transmitted from a predetermined number or more of vehicles. In addition, a local rule in this specification means a phenomenon that occurs specifically according to a position or a date and time. The local rules more specifically mean a peculiar phenomenon that requires a high degree of attention relative to attention in driving or driving a normal vehicle depending on location or date and time.

If a vehicle occupied by an occupant who does not know its local rule arrives at the location where the local rule exists, the occupant's emotion is likely to change to a negative emotion due to the fact that the occupant did not know the local rule. For example, if a driver, who is an occupant of the vehicle, did not know a local rule that exists in a predetermined location, the driver's emotion may become a negative emotion if the driver performs a partially erroneous driving operation because the occupant did not know this local rule. Accordingly, an embodiment in accordance with the present disclosure utilizes the phenomenon that the emotion of an occupant in a vehicle that has reached a location where a local rule exists is liable to change to a negative emotion by not knowing the local rule. Thus, the information processing device that acquires the position information from the vehicle can automatically detect the place where the local rule is occurring or collect the position information. As a result, you can reduce the need to collect local rules. Further, in the information processing apparatus, by reflecting the notification result of each vehicle in real time, it is possible to detect the occurrence and disappearance of local rules in real time.

Furthermore, by transmitting information about the occurrence or disappearance of the local rule from the information processing apparatus to the vehicle, notifying the vehicle of the presence of the local rule, it is possible to promptly notify the occurrence or disappearance of the local rule to the driver of the vehicle.

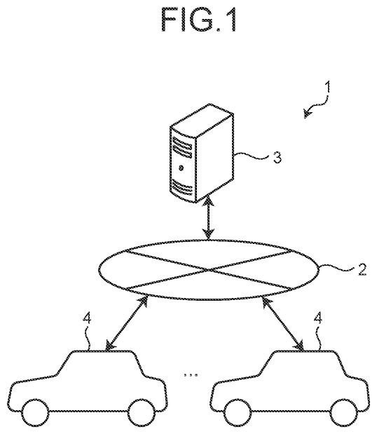

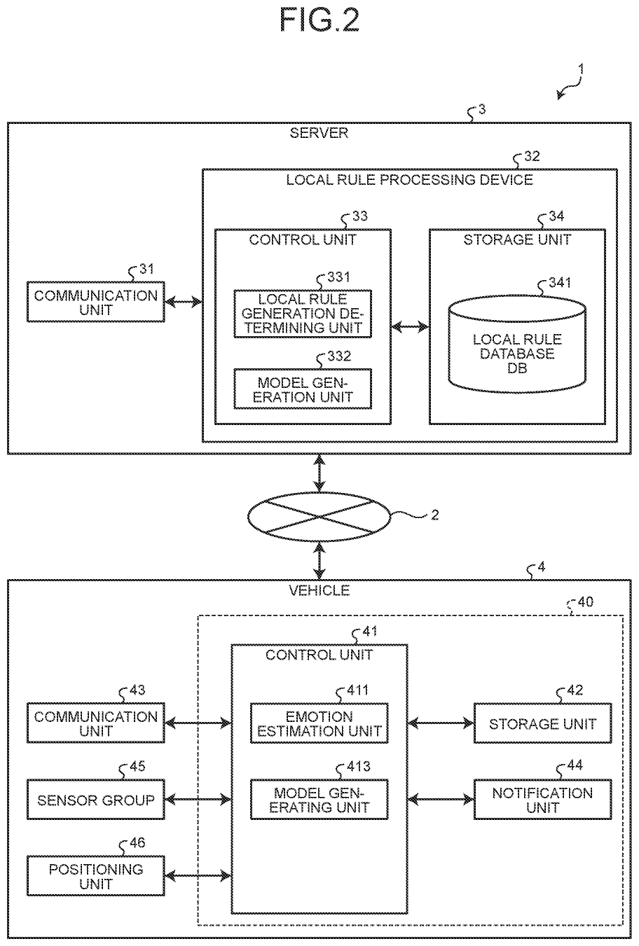

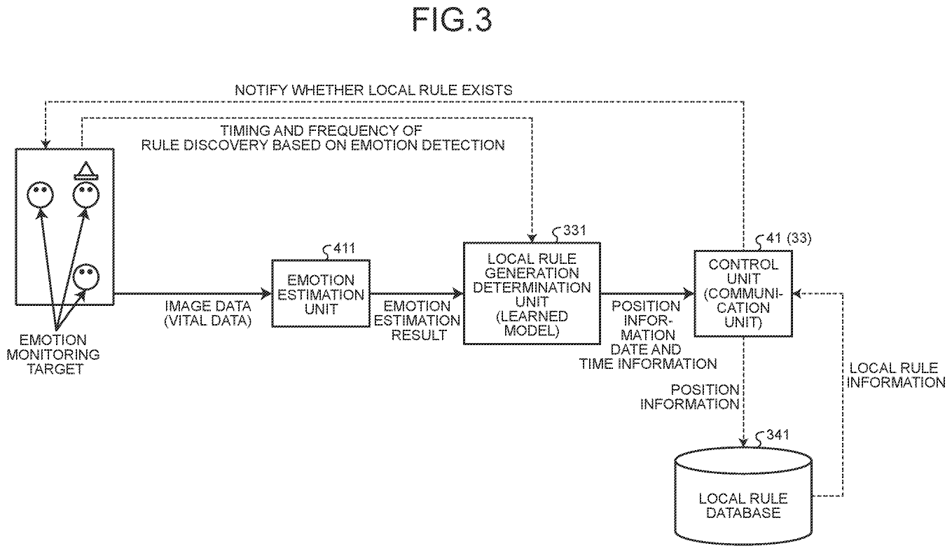

Next, an information processing system according to an embodiment of the present disclosure based on the above principles will be described. FIG. 1 illustrates an information processing system according to an embodiment. FIG. 2 is a block diagram illustrating an information processing system 1 according to an embodiment. FIG. 3 is a diagram for explaining a flow of estimating a negative emotion of an occupant of a vehicle in an embodiment.

As illustrated in FIG. 1, the information processing system 1 includes a server 3 and the vehicle 4 capable of transmitting and receiving information to and from each other through the network 2. The server 3 and the plurality of vehicle 4 can communicate via the network 2. The vehicle 4 transmits information related to emotion from the mounted device 40 mounted thereon to the server 3. The server 3 transmits information to support the driving of the local rule information to the vehicle 4 using the information received from the vehicle 4 to the vehicle 4. In the following description, the transmission and reception of information between each component is performed via the network 2, but the description of each time this point is omitted.

The network 2 consists of the Internet network and a cellular telephone network. The network 2 may include, for example, a public communication network, such as the Internet, a Wide Area Network (WAN), a telephone communication network, such as a cellular telephone, or another communication network, such as a radio communication network, such as a WiFi (registered trademark).

### Server

As illustrated in FIG. 2, the server 3 as an information processing device that communicates with the vehicle 4 collects position information regarding local rules that exist while the vehicle 4 is traveling. The server 3 has a typical computer configuration that can communicate over the network 2. The server 3 includes a communication unit 31 and a local rule processing device 32. The local rule processing device 32 includes a control unit 33 and a storage unit 34.

In the present embodiment, various kinds of information are transmitted from each vehicle 4 to the server 3 at a predetermined timing. The vehicle information as the moving object information of the various information includes vehicle identification information and sensor information. The sensor information of the various information includes imaging information obtained by imaging the occupant of the vehicle 4 in the cabin. The travel information as the movement information among the various information includes information related to the travel such as the travel route and the position information as the movement route of the vehicle 4. User information includes user identification information and personal information. The user identification information includes information for identifying users such as a driver (hereinafter, driver) of the vehicle 4 and a driver or an occupant riding on the vehicle 4 from each other. Although the users to be monitored for emotion are mainly drivers, it is also possible to use the users to be monitored for emotion as crew members. User state information, for example, includes information about the emotion of the user. The personal information includes, as information about the user itself, for example, name, age, address, birth date, and user individual information such as age, and behavior pattern information such as driving history. The above-described information is not necessarily limited to the illustrated information.

The control unit 33 having hardware specifically includes a processor such as a Central Processing Unit (CPU), a Digital Signal Processor (DSP), and a Field-Programmable Gate Array (FPGA), and a main storage unit such as a Random Access Memory (RAM) and a Read Only Memory (ROM).

The storage unit 34 is composed of a storage medium selected from an Erasable Programmable ROM (EPROM), a Hard Disk Drive (HDD), and a removable medium. The removable media includes, for example, a Universal Serial Bus (USB) memory or a disk recording medium. A Disc recording media may be Compact Disc (CD), a Digital Versatile Disc (DVD), or a Blu-ray (registered trademark) Disc (BD). The storage unit 34 may store various programs, various tables, and various databases. The various programs include, for example, an Operating System (OS). The various databases are local rule databases 341 in this embodiment.

The control unit 33 loads and executes the program stored in the storage unit 34 to the work area of the main storage unit. The control unit 33 can realize various functions of the control unit 33 through the execution of the program. Specifically, the control unit 33 can realize the functions of the local rule generation determination unit 331 and the model generation unit 332 through the execution of the program.

The local rule generation determination unit 331 determines whether the local rule is occurring using the occurrence determination model. The local rule generation determination unit 331 can determine whether the local rule is generated based on the learning model previously learned by the machine learning or the generation determination model that is a learned model. The occurrence determination model is a model that determines the occurrence of local rules, and is a learned model that is learned by machine learning. When using the occurrence determination model, the input parameters are, for example, the estimated result of the emotion of the occupant (emotion estimation result) and image data which is the captured image information outside the vehicle received from the vehicle 4. The output parameter is, for example, a probability value of occurrence of a local rule. When it is determined that the local rule is occurring, the local rule generation determination unit 331 outputs both the position information related to the location where the local rule occurred and the date and time information related to the time at which the local rule occurred.

The model generation unit 332 generates a generation determination model that is a learning model by machine learning. The learned model or the learning model can be generated by machine learning such as deep learning using a neural network, for example, using an input/output data set between a predetermined input parameter and an output parameter as teacher data. In supervised learning to generate a generation decision model, the user's emotion estimation result and the outside image data captured by the outside camera are used as input parameters for learning, and the occurrence of a local rule is used as output parameter for learning. The model generation unit 413 can generate a generation determination model using these input and output data sets as the teacher data.

### Vehicle

The vehicle 4 as a moving body can be employed a vehicle that travels by driving by a driver. Incidentally, it may be adopted a semi-automatic driving type vehicle 4 capable of autonomous running in accordance with a travel command given by a predetermined program or the like as the vehicle 4. The vehicle 4 can be moved toward a desired destination by the user or the user on board by operating a steering or the like. In addition, a moving body other than a vehicle may be employed instead of the vehicle 4, and the moving body includes a light vehicle such as a two-wheeled vehicle and those moving on other roads. That is, in the present embodiment, the motorcycle, a motorcycle, such as a bicycle or kick board, a motorcycle, a triple, a bus, and a truck, for example, with a motor and a battery, may also be adopted.

The vehicle 4 includes a control unit 41, a storage unit 42, a communication unit 43, a notification unit 44, a sensor group 45, and a positioning unit 46. The control unit 41, the storage unit 42, and the mounting device 40 is configured by the notification unit 44. The mounting device 40 is a vehicle-mounted device mounted on the vehicle 4. The control unit 41, the storage unit 42, and the communication unit 43, respectively, physically and functionally have the same configuration as the control unit 33, the storage unit 34, and the communication unit 31.

The control unit 41 as a vehicle control unit having hardware comprehensively controls the operation of various components mounted on the vehicle 4. The control section 41 further loads and executes the program stored in the storage section 42 into the work area of the main storage section, and through execution of the program, can realize the functions of the emotion estimation section 411 and the model generation section 413. An emotion estimation model for realizing the emotion estimation unit 411 is stored in the storage unit 42. Thus, the emotion estimation unit 411 can estimate the emotion of the occupant from the captured image data of the occupant obtained by imaging the vehicle 4 interior and the vital data including the biometric information of the occupant measured by the sensor group 45.

The communication unit 43 performs communication with the server 3 by wireless communication via the network 2. The notification unit 44 is configured to be able to notify the outside of the predetermined information. The sensor group 45 includes, for example, a vehicle interior sensor or a vehicle interior imaging camera capable of detecting various situations in the vehicle interior, a vehicle exterior sensor or a vehicle exterior imaging camera capable of detecting various situations outside the vehicle, and the like. The sensor group 45 may further include sensors for traveling of the vehicle 4, such as a vehicle speed sensor, an acceleration sensor, or a fuel sensor. The sensor information detected by various sensors and cameras constituting the sensor group 45 is outputted to the control section 41 via a vehicular information network (Control Area Network: CAN) composed of a transmission path connected to various sensors. The sensor group 45 may include a wearable terminal worn by a driver or an occupant (hereinafter, a driver or the like) riding on the vehicle 4, and may detect the state of the occupant by detecting vital information such as the body temperature, pulse, EEG, blood pressure, and perspiration status of the occupant.

That is, as illustrated in FIG. 3, the emotion estimation unit 411 of the control unit 41 estimates emotions such as a driver using various information acquired from the sensor group 45 of the vehicle 4, here, image data or vital data. The emotion estimation unit 411 estimates whether the driver or the like is negative emotion using the emotion estimation model. The emotion estimation unit 411 can perform emotion estimation such as a driver based on a learning model previously learned by machine learning or an emotion estimation model that is a learned model. When an emotion estimation model is used, the input parameters are, for example, image data of an occupant or vital data of an occupant. The output parameter is, for example, a probability value of occupant discomfort. That is, the emotion estimation unit 411 is configured to be able to determine the emotion of the occupant from the expression of the occupant of the vehicle 4 by Artificial Intelligence (AI) using the learning model.

The model generation unit 413 is configured similarly to the model generation unit 332. In supervised learning to generate an emotion estimation model as a learning model, image data and vital data of users acquired in the past are used as input parameters for learning. In supervised learning for generating an emotion estimation model, information indicating that a user such as a driver has negative emotion is used as an output parameter for learning. The information indicating that the user is in a negative emotion is information indicating a preset negative emotion. In other words, the model generation unit 413 performs machine learning based on the image data and the vital data of the user that satisfy the condition determined as the normal state as the learning input parameter by setting in advance the condition that the emotion of the user is judged as the normal state as the output parameter. The model generation unit 413 can generate an emotion estimation model using these input and output data sets as the teacher data. The model generation unit 413 stores the generated emotion estimation model in the storage unit 42. The generated emotion estimation model is a learning model that estimates the driver's negative emotion. When the emotion estimation unit 411 estimates negative emotion such as a driver using the emotion estimation model, vital information such as a driver may be used as information acquired from the vehicle 4.

The positioning section 46 serving as a position information acquiring section detects the position of the vehicles 4 by receiving radio waves from GPS satellites by Global Positioning System (GPS) sensors. The detected position and the travel path is retrievably stored in the storage unit 42 as information of the position information and the travel path in the travel information.

The map database stored in the storage unit 42, the notification unit 44, and the positioning unit 46 constitute a car navigation system. In the car navigation system, the notification unit 44 constitutes a display unit for displaying images, images, and character information, and a sound output unit for generating sounds such as sounds and warning sounds. The signal corresponding to the various kinds of operation contents received by receiving the input of the user operation from the input unit may be output to the control unit 41. The car navigation system notifies a user such as a driver by the notifying unit 44 of information including a position of a road on which the vehicle 4 is currently traveling and a route to a destination.

### Determination Collection Method of Local Rules

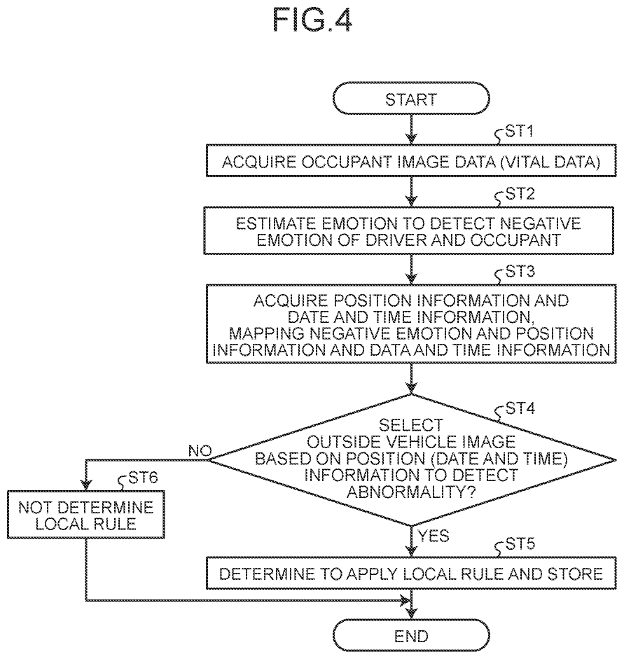

Next, the determination collection method of local rules which is the information processing method executed by the information processing system 1 described above will be described. FIG. 4 is a flowchart for explaining an information processing method according to the present exemplary embodiment. Incidentally, the vehicle 4 to be described below is a vehicle 4 of one of a large number of vehicles 4, the processing described below is executed in parallel for a plurality of vehicles 4.

As illustrated in FIG. 4, first, the imaging camera of the sensor group 45 of the vehicle 4 in step ST1 captures such drivers in the vehicle 4 cabin. The sensor group 45 outputs the captured image data to the control unit 41. Similarly, the wearable terminal of the sensor group 45 measures biological information such as a driver. The sensor group 45 outputs the measured biological information to the control unit 41 as vital data. The control unit 41 stores the acquired image data and vital data in the storage unit 42. Incidentally, the outside camera of the sensor group 45 is continuously imaging the outside during the running of the vehicle 4.

Next, the emotion estimation unit 411 of the control unit 41 proceeds to step ST2 to read the image data, the vital data, and the emotion estimation model from the storage unit 42. The emotion estimation unit 411 inputs the read image data or vital data to the emotion estimation model. The emotion estimation unit 411 outputs the information that became negative emotions out of the emotion estimation results by the emotion estimation model. That is, the emotion estimation unit 411 outputs the information of the emotion estimation result to the control unit 33 of the server 3 when the emotion becomes negative due to the change of the emotion estimated based on the image data or the vital data.

Next, the local rule generation determination unit 331 of the control unit 41 proceeds to step ST3 to acquire the position information and the date and time information of the vehicle 4 at the time when the information of the emotion estimation result is acquired from the emotion estimation unit 411, that is, when the negative emotion appears in the driver or the like. That is, the local rule generation determination unit 331 detects the place where the negative emotion change has occurred by the outboard camera of the positioning unit 46 or the sensor group 45 and identifies the time (date and time information) and the place (position information) that affected the negative emotion from a plurality of information such as information acquired from the sensor group 45. It is also possible to include, as multiple information, attribute information such as, for example, a residential area or a travel history related to a driver.

By inputting the attribute information to the local rule generation determination unit 331, if the attribute information can be considered, the accuracy of determining the occurrence of the local rule can be improved.

Subsequently, the local rule generation determination unit 331 maps the location information and the date and time information of the place where the specified change in negative emotion occurs to the map information stored in the storage unit 42. The local rule generation determination unit 331 stores the mapped information as the local rule information in the storage unit 42. This makes it possible to create data by superimposing locations and dates where drivers have changed to negative feelings on map data. As a result, the location information generated by the local rule due to the date and time information is converted into big data. In addition, the mapping by the local rule generation determination unit 331 performs marking on the portion of the map data based on the location information and the date and time information of the place where the driver or the like has changed to a negative emotion. The local rule generation determination unit 331 performs marking on the map data by collecting the position information and day information of the location where the driver or the like has changed to a negative emotion from a plurality of vehicles 4. Thus, the local rule database 341 is big-data. That is superimposed positional information and date and time information with respect to the map information, a large number of positional information and date and time information is accumulated in the map information from a plurality of vehicles 4 is mapped.

Next, the local rule generation determination unit 331 proceeds to step ST4 to extract the outside image data of the outside camera from the storage unit 42 based on the mapped position information and the date and time information. The local rule generation determination unit 331 reads the occurrence determination model from the storage unit 34. The local rule generation determination unit 331 determines whether a local rule exists based on the number of notifications for each mapped position information and each date and time information in the local rule information. Note that not only the absolute number of notifications but also statistically significant numbers such as the frequency of notifications and the number of deviations from the average of the absolute number of notifications and the variance can be adopted.

Based on the location information and the date and time information in the mapped local rule information, the local rule generation determination unit 331 stores the location information and the date and time information in which the number of notifications exceeds a predetermined threshold in the local rule database 341 of the storage unit 34 as the local rule information. It should be noted that the predetermined threshold value can be set various values that the number of occupants are considered to generate negative emotions is large.

The local rules are described in detail here. That is, the determination of the presence or absence of the local rule by the local rule generation determination unit 331 uses the position information and the date and time information when the driver or the like transmitted from the vehicle 4 changes to a negative emotion. Furthermore, the local rule generation determination unit 331 can perform the determination using the following information. In the case of executing a judgment using the following information, machine learning is performed by inputting the following information as an input parameter for learning.

### Information Used for Judgment

(1) Drivers' dwellings and driving history of each vehicle 4. The driving history includes information such as area, time zone, and season.

(2) Sensor information sensed by sensor group 45. It is possible to use it for explanatory variables by judging whether it is in the state of the defect or not based on the sensor information.

(3) Information on important points in traffic collected from traffic information servers and big data. Negative emotions are likely to occur in drivers, etc. because there are many places where traffic rules themselves are difficult to understand, so information on points requiring attention in traffic is collected.

Examples of this caution point are as follows.
(i) Station Rotary, Traffic-rule-changed locations
(ii) Locations where roads have changed
(iii) Locations where animals are likely to fly out during breeding seasons, etc.

(4) Locations that differ from ordinary specific locations that can be judged by external cameras, etc. can be listed as follows.

(i) Places where traffic jams occur (location information), time zones (date and time information), etc.

(ii) Places where visibility is poor (location information) Such places are prone to popping out of pedestrians, other vehicles, etc.

(iii) For example, newly paved roads such as one-way traffic, etc.

(5) Areas where abnormalities occur are recognized as areas where local rules exist.

The range is extracted as local rules the presence (i) of other vehicles driven by a driver that does not change to the experienced negative emotion traveled under the same conditions.

When the local rule generation determination unit 331 determines that the local rule exists (step ST4: Yes), the process proceeds to step ST5. In step ST5, the control unit 41 stores the local rule information in the storage unit 42 in association with the position information and the date and time information in steps ST3 and ST4. The control unit 41 transmits the local rule information to the server 3. In the server 3, the control unit 33 stores the received local rule information in the local rule database 341 in a readable manner. Thus, the determination processing of the local rule is completed.

On the other hand, when the local rule generation determination unit 331 determines that there is no local rule (step ST4: No), the process proceeds to step ST6. In step ST6, the control unit 41 stores the local rule information generated by changing the driver to a negative emotion as a flag that is not a local rule in the storage unit 42. Here, based on the local rule information, when the increase rate of the local rule information based on the negative feeling accumulated in the local rule database 341 of the server 3 becomes less than or equal to a predetermined threshold value, the local rule generation determination unit 331 determines that the local rule no longer occurs, that is, no attention is necessary at the place and date and time, and deletes the local rule information from the local rule database 341. This improves the accuracy of the local rule information by enabling immediate occurrence and disappearance of local rules. As a result of the above, the determination process of the local rule ends.

### How to Use Local Rules

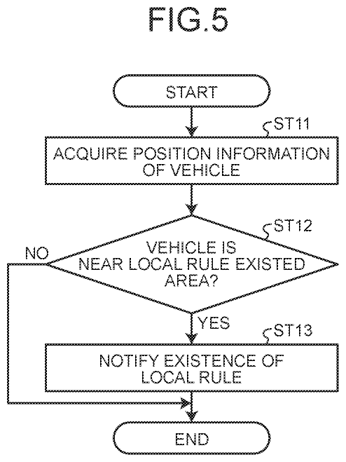

Next, we will explain how to use local rules by information processing system 1. FIG. 5 is a flowchart for explaining a notification method for notifying the local rule to the vehicle. In the present embodiment, when approaching a place where the existence of the local rule is likely to be high, the presence of the local rule is informed to a user such as a driver of the vehicle 4. Incidentally, the flowchart described below is repeatedly executed.

That is, the control section 33 of the server 3 acquires the position data from the vehicle 4 in ST11 of steps. Next, the process proceeds to the step ST12, and the local rule generation determination unit 331 of the control unit 33 reads the local rule information from the local rule database 341. Local rule generation determination unit 331 determines whether the position information of the vehicle 4 is within a predetermined distance range in advance with respect to the position where the local rule exists. The predetermined distance may be a distance along the road where the vehicle 4 travels, it may be a circle radius around the vehicle 4. The local rule generation determination unit 331 extracts a time zone in which the local rule may occur from the date and time information in the travel of the vehicle 4, the time zone in which the vehicle 4 is traveling, the determination of the distance when included in the time zone it may be.

If the local rule generation determination unit 331 in step ST12 determines that there is no local rule within a predetermined distance from the position of the vehicle 4 (step ST12: No), the notification process of the local rule ends.

On the other hand, when the local rule generation determination unit 331 in the step ST12 determines that the local rule is present within a predetermined distance from the position of the vehicle 4 (step ST12: Yes), the process proceeds to step ST13. In this case, as illustrated in FIG. 3, the local rule generation determination unit 331 transmits the local rule information corresponding to the position information of the position where the local rule in which the vehicle 4 is approaching exists through the communication unit 31 to the vehicle 4. The local rule generation determination unit 331 may transmit the information in which the local rule exists instead of transmitting the local rule information. In the vehicle 4 which has received the information, and outputs the information indicating that the local rule has occurred from the notification unit 44. Thus notification processing of the local rule ends.

Instead of the location (location information) where the local rule exists and the date and time that occurs (date and time information), based on the location and date and time where the local rule is likely to exist, it may execute the notification processing of the local rule. Here, the following example shows where and when local rules are most likely to exist. That is, when the traffic environment differs depending on the time series, day of the week, or season, such as when rush in the morning and evening. In this case, based on the presence of different traffic environments and the information of the emotion estimation result, it may be informed based on the location information by determining the presence or absence of the local rule. In addition, when there is a high probability of the presence of local rules, the vehicle 4 may be automatically controlled by the control unit 41 according to the contents of the local rules.

According to an embodiment of the present disclosure described above, since the driver or the like can know in advance the presence or occurrence of local rules, it is possible to suppress the accident by eliminating the driver's anxiety during operation.

Although the embodiments of the present disclosure have been described specifically, the present disclosure is not limited to the above-described embodiments, and various modifications based on the technical philosophy of the present disclosure and embodiments that combine mutual embodiments can be adopted. For example, the input and output data sets and the teacher data listed in the above-described embodiment are only examples, and may use input and output data sets and the teacher data different from this as necessary.

For example, in the above-described embodiment, a method of constructing a learning model by the model generation unit 332, 413 is not particularly limited, and various machine learning methods such as a deep learning using a neural network, a support vector machine, a decision tree, a simple Bayesian, and a k neighborhood method can be used. Also, semi-supervised learning may be used instead of supervised learning. Furthermore, reinforcement learning or deep reinforcement learning may be used as machine learning.

The learning model that estimates emotion may also be generated in the vehicle 4 or may be generated outside the vehicle 4. When generating outside the vehicle 4, for example, a server installed outside the vehicle 4 may generate an emotion estimation model. In this case, the vehicle 4 acquires an emotion estimation model by wireless communication with the server. The emotion estimation model acquired from the server is stored in the storage unit 42. Further, by storing the emotion estimation model in the storage unit 42, it is possible to update the emotion estimation model to the latest information. Similarly, a learning model for determining the occurrence of a local rule may be generated by server 3 or may be generated by an information processing device external to server 3. In this case, the generation determination model is acquired by the wireless communication between the server 3 and the external information processing device. The generation determination model acquired from the external information processing apparatus is stored in the storage unit 34. Further, by storing the generation determination model in the storage unit 34, it is possible to update the generation determination model to the latest information.

### Information Processing System

In addition, as another embodiment, it is also possible to divide the functions of the control units 33 and 41, the storage units 34 and 42, the local rule generation determination unit 331, the emotion estimation unit 411, and the model generation unit 332, 413 and execute them by a plurality of devices that can communicate with each other through the network 2. For example, at least a portion of the functions of the control unit 33, 41 may be executed in the first device having a first processor. At least part of the functions of the emotion estimation unit 411 may be executed in the second device having the second processor. At least part of the functions of the local rule generation determination unit 331 may be executed in the third device having the third processor. At least a part of the functions of the model generation unit 332, 413 may be executed in the fourth device having the fourth processor. Here, each of the first to fourth devices may be configured to send and receive information from each other via a network 2 or the like. In this case, at least one of the first to fourth devices, for example, at least one of the first device and the second device, may be mounted on the vehicle 4.

### Recording Medium

In one embodiment described above, a program capable of executing a processing method by the server 3 and the mounting device 40 can be recorded on a recording medium that can be read by a computer or other machine or device (hereinafter, a computer or the like). By causing the computer or the like to read and execute the program of the recording medium, the computer or the like functions as the control unit 33 of the server 3 and the control unit 41 of the vehicle 4. Here, a recording medium that can be read by a computer or the like refers to a non-temporary recording medium that can store information such as data or programs by electrical, magnetic, optical, mechanical, or chemical action and can be read from a computer or the like. Among such recording media, removable from a computer or the like includes, for example, a memory card such as a flexible disk, a magnetic optical disk, a CD-ROM, a CD-R/W, a Digital Versatile Disk (DVD), a BD, a DAT, a magnetic tape, a flash memory, and the like. A Hard Disks, a ROM, and the like are fixed to a computer or the like as recording media. In addition, an SSD can be used as a removable recording medium such as a computer or a recording medium fixed to a computer.

### Other Embodiments

Further, in the server 3 and the vehicle 4 according to an embodiment, the above-described “unit” can be read as a “circuit” or the like. For example, the communication unit can be read as a communication circuit.

The program to be executed by the server 3 or the vehicle 4 according to one embodiment may be stored on a computer connected to a network such as the Internet and may be provided by being downloaded through the network.

In the description of the flowchart in the present specification, it has been clarified the relationship before and after the processing between the steps using expressions such as “first,” “thereafter,” “following,” etc., the order of the processing necessary for carrying out the present embodiment is not uniquely defined by their expressions. That is, the order of processing in the flowcharts described herein may be varied to the extent that there is no discrepancy.

In addition, instead of a system equipped with a single server, an edge computing technology that can efficiently communicate large amounts of data and shorten computing time may be applied by distributing and arranging terminals that can execute some processing of the server at a location physically close to the information processing device.

Further effects and variations can be readily derived by one skilled in the art. The broader aspects of the present disclosure are not limited to the specific details and representative embodiments represented and described above. Accordingly, various modifications are possible without departing from the spirit or scope of the overall concept defined by the appended claims and their equivalents.

According to the present disclosure, it is possible to efficiently identify a place or a date and time where a specific rule is present.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a mounting device, mounted on a moving body, configured to acquire position information of the moving body; and
an information processing device configured to receive and transmit information from and to the mounting device,
wherein the mounting device includes a moving body control unit that is configured to input a captured image of an occupant in the moving body to a learning model as an input parameter, output an estimation result of an emotion of the occupant as an output parameter, and, when it is determined that the emotion of the occupant is a negative emotion on a basis of the output estimation result, transmit date and time information and the position information of the moving body at a time when the negative emotion is appeared to the information processing device, and
the information processing device includes a control unit that is configured to acquire the date and time information and the position information transmitted from the movable body and store the date and time information and the position information in a storage unit, and identify a location or date and time when a specific rule occurs on a basis of a number of the stored position information and the date and time information.

2. The information processing system according to claim 1,
wherein the moving body control unit of the mounting device is configured to transmit the position information and time information, which are related to the timing when the negative emotion is appeared, to the information processing device.

3. The information processing system according to claim 1,
wherein the control unit of the information processing device is configured to store the position information of the location, where the specific rule transmitted from the mounting device occurred in a storage unit to update or add information of the specific rule, associates the position information and the time information of the location at the time when the negative emotion is expressed on the occupant with user information of the occupant in association with map data, and notify the occupant of a possibility of occurrence of the specific rule on a basis of the position information that is highly likely to generate the specific rule.

4. The information processing system according to claim 1,
wherein the control unit is configured to store the position information of a location where it is determined that a change of an emotion of the occupant in the moving body is greater in association with peripheral data captured by an imaging camera capturing an image of outside from the moving body in the storage unit.

5. The information processing system according to claim 1,
wherein the control unit is configured to acquire information related to the specific rule from outside on a basis of the position information and the date and time information and determine whether the specific rule exists on a basis of personal information of the occupant in the moving body.
